(19) United States
(12) Patent Application Publication
(10) Pub. No.: US 2021/0197510 A1
(43) Pub. Date: Jul. 1, 2021

(54) METHOD OF FORMING A BELT STRUCTURE FOR A PNEUMATIC TIRE

(71) Applicant: The Goodyear Tire & Rubber Company, Akron, OH (US)

(72) Inventors: Peijun Liu, Hudson, OH (US); Matthew Jeremy List, Canton, OH (US); Robert John Boehlefeld, Brecksville, OH (US)

(21) Appl. No.: 17/189,406

(22) Filed: Mar. 2, 2021

Related U.S. Application Data
(62) Division of application No. 15/825,628, filed on Nov. 29, 2017.

(51) Int. Cl. B29D 30/30; B29D 30/24

(52) U.S. Cl. CPC B29D 30/3035; B60C 9/18; B29D 30/242

(57) ABSTRACT

A method of forming a belt structure for a tire includes providing a drum having a center section. A first drum edge is near a first edge of the center section and a second drum edge is near a second edge of the center section. A first end surface extends from the center section first edge to the drum first edge and a second end surface extends from the center section second edge to the drum second edge, and a radius of each end surface is smaller than the center section radius. A rubber strip reinforced by a plurality of cords includes an outer edge and an inner edge. The strip is wound about the drum, turning from a first winding angle to a second winding angle on an end surface to reduce the tension and length differential between cords at the outer edge and inner edge of the strip.

### FIELD OF THE INVENTION

The invention relates to pneumatic tires, which include a belt structure. More particularly, the invention relates to the forming of radial ply tires for use in aircraft, trucks and other high load applications. Specifically, the invention is directed to a method of forming a belt structure for a tire that promotes a uniform tension on the cords in the strips of the belt structure and a uniform length of the cords across the strips.

### BACKGROUND OF THE INVENTION

In the manufacture of a tire, the tire is typically built on the drum of a tire-building machine, which is known in the art as a tire building drum. Numerous tire components are wrapped about and/or applied to the drum in sequence, forming a cylindrical-shaped tire carcass. The tire carcass is then expanded into a toroidal shape for receipt of the remaining components of the tire, such as a belt package and a rubber tread. The completed toroidally-shaped unvulcanized tire carcass, which is known in the art at that stage as a green tire, is then inserted into a mold or press for forming of the tread pattern and curing or vulcanization.

In regard to the belt package, a strip of rubber is reinforced with a plurality of cords, and the strips are applied in layers, with at least one layer, and typically at least two layers, constituting a belt. Multiple belts are employed to make up the belt package. In the prior art, belt packages employed belts in which the ends of the strips were cut at the shoulder of the tire, which corresponded to a point at or near the edge of the drum that was used to rotate the carcass in the application of the belt package.

For tires that support heavy loads, such as truck tires or aircraft tires, belt packages were developed that employ strips which are wound about the drum in a zigzag pattern, thereby creating a zigzag belt structure. A zigzag belt structure is formed of at least two layers of strips that are interwoven and eliminates cut belt endings at the shoulder of the tire, which desirably improves the durability of the tire.

However, the change of direction in such zigzag winding of the strips on the drum may create a tension on the cords on the outside edge of a strip that is different from the tension on the cords on the inside edge of the strip. Such a difference in tension is undesirable, as uniform tension on the cords in a belt is an optimum condition for the tire. The zigzag winding may also result in different cord lengths across a strip, as the cords on the inside edge extend for a lesser distance than the cords on the outside edge of the strip. Such a difference in cord lengths is undesirable, as uniform length of the cords in a strip is another optimum condition for a tire. In addition, non-uniform tension on the cords and non-uniform lengths of the cords may lead to non-uniform spacing between the cords and/or the strips, which is undesirable.

Therefore, it is desirable to provide a method of forming a belt structure for the tire that optimizes zigzag winding parameters of the strips in the belt structure to promote a uniform tension on the cords in each strip, a uniform length of the cords across each strip, and uniform spacing between the cords in each strip.

### SUMMARY OF THE INVENTION

According to an aspect of an exemplary embodiment of the invention, a method of forming a belt structure for a pneumatic tire includes the step of providing a drum. The drum includes an axially-extending circumferential center section, and the center section includes a first center section edge and a second center section edge. An axially-disposed circumferential drum first edge is disposed near the first edge of the center section and an axially-disposed circumferential drum second edge is disposed near the second edge of the center section. A first end surface extends radially inwardly from the first edge of the center section to the drum first edge and includes a radius that is smaller than a radius of the center section. A second end surface extends radially inwardly from the second edge of the center section to the drum second edge and includes a radius that is smaller than a radius of the center section. At least one rubber strip that is reinforced by a plurality of cords is provided, and includes an axially outer edge and an axially inner edge. The at least one strip is wound about the drum in a circumferential direction between the first and second drum edges. The at least one strip is turned from a first winding angle to a second winding angle on the first end surface, in which the turning reduces a difference of at least one of a length and a tension between cords that are disposed adjacent the axially outer edge of the strip and cords that are disposed adjacent the axially inner edge of the strip.

### Definitions

“Axial” and “axially” mean lines or directions that are parallel to the axis of rotation of the tire.

“Axially inward” and “axially inwardly” refer to an axial direction that is toward the axial center of the tire.

“Axially outward” and “axially outwardly” refer to an axial direction that is away from the axial center of the tire.

“Bead” means that part of the tire comprising an annular tensile member wrapped by ply cords and shaped, with or without other reinforcement elements such as flippers, chippers, apexes, toe guards and chafers, to fit the design rim.

“Carcass” means the tire structure apart from the belt structure, tread, undertread, and sidewall rubber over the plies, but including the beads.

“Circumferential” means lines or directions extending along the perimeter of the surface of the annular tread perpendicular to the axial direction.

“Cord” means one of the reinforcement strands of which the plies in the tire are comprised.

“Equatorial plane (EP)” means the plane perpendicular to the tire's axis of rotation and passing through the center of its tread.

“Innerliner” means the layer or layers of elastomer or other material that form the inside surface of a tubeless tire and that contain the inflating fluid within the tire.

“Radial” and “radially” mean lines or directions that are perpendicular to the axis of rotation of the tire.

“Radially inward” and “radially inwardly” refer to a radial direction that is toward the central axis of rotation of the tire.

“Radially outward” and “radially outwardly” refer to a radial direction that is away from the central axis of rotation of the tire.

“Radial-ply tire” means a belted or circumferentially-restricted pneumatic tire in which the ply cords which extend from bead to bead are laid at cord angles between about 65 to about 90 degrees with respect to the equatorial plane of the tire.

“Winding” means the pattern of the strip formed by moving a belt strip application head around a tire building drum, tire or core.

“Zigzag belt” means a belt structure formed of at least two layers of strips that are interwoven and wound about the drum in a back-and-forth pattern between the drum edges.

### BRIEF DESCRIPTION OF DRAWINGS

The invention will be described by way of example and with reference to the accompanying drawings, in which:

FIG. 1 is a schematic cross-sectional view of an exemplary tire formed by the method of the present invention;

FIG. 2 is a schematic perspective view of an exemplary tire building drum with a zigzag belt structure of a tire of the present invention being formed;

FIG. 3 is a schematic end view of the tire building drum and zigzag belt structure shown in FIG. 2;

FIG. 4 is a fragmentary schematic representation of a portion of a strip of a zigzag belt structure formed by the method of the present invention;

FIG. 5 is a fragmentary schematic representation of a portion of an exemplary tire building drum with a strip of a zigzag belt structure formed by the method of the present invention;

FIG. 6A is schematic representation of a cross section of a tire building drum of the prior art;

FIG. 6B is a schematic representation of a cross section of an exemplary tire building drum used in the method of the present invention;

FIG. 6C is a schematic representation of a cross section of another exemplary tire building drum used in the method of the present invention; and

FIG. 6D is a schematic representation of a cross section of yet another exemplary tire building drum used in the method of the present invention.

Similar numerals refer to similar parts throughout the drawings.

### DETAILED DESCRIPTION OF THE INVENTION

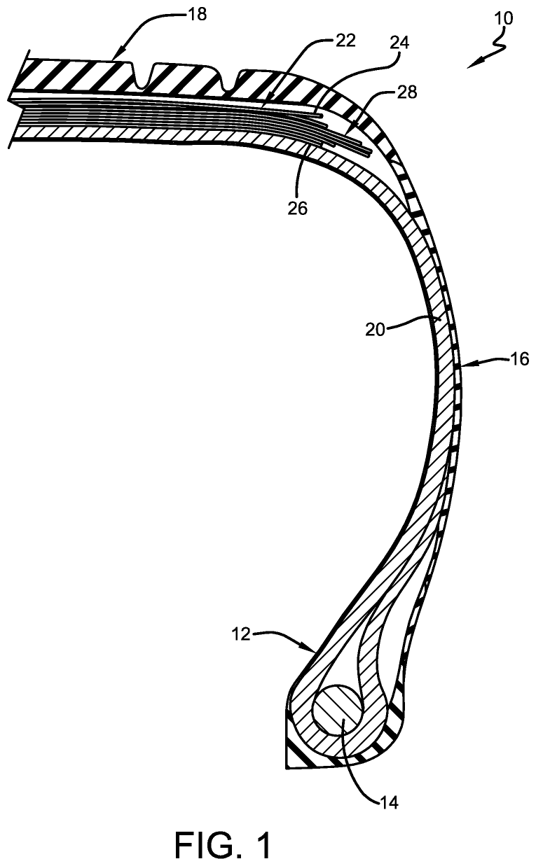

An exemplary embodiment of a tire formed according to the method of the present invention is indicated generally at 10, and is shown in FIG. 1. The tire 10 includes a bead area 12 and a bead core 14 embedded in the bead area. A sidewall 16 extends radially outward from the bead area 12 to a ground-contacting tread 18. The tire 10 is reinforced by a carcass 20 that toroidally extends from one bead area 12 to a second bead area (not shown), as known to those skilled in the art. The carcass 20 includes at least one ply that preferably winds around each bead core 14.

A belt reinforcement package 22 is disposed between the carcass 20 and the tread 18. The belt reinforcement package 22 may employ specific configurations as desired. For example, the belt reinforcement package 22 may include at least one of a radially outer belt structure 24 and a radially inner belt structure 26. A zigzag belt package or belt structure 28 preferably is disposed between the radially outer belt structure 24 and the radially inner belt structure 26. Of course, different combinations of belt structures may be employed, and the outer belt structure 24 and inner belt structure 26 may be of any configuration, such as spiral, cut, zigzag, and the like.

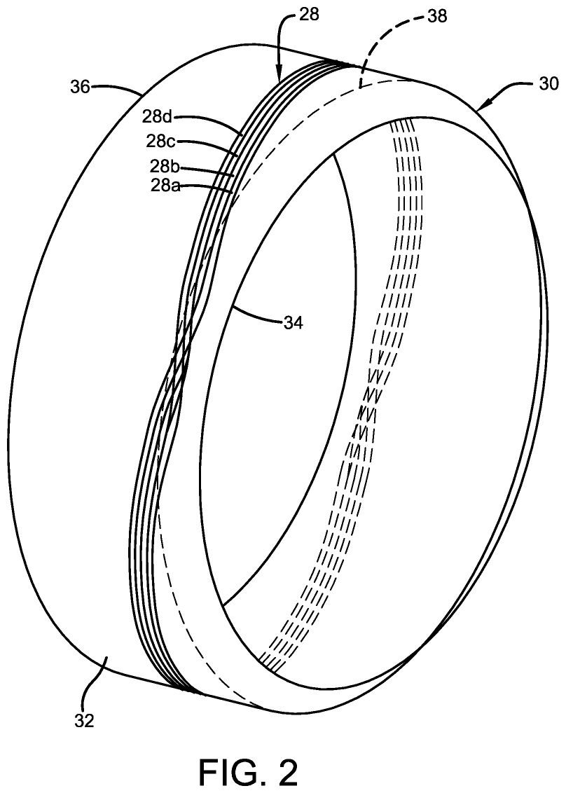

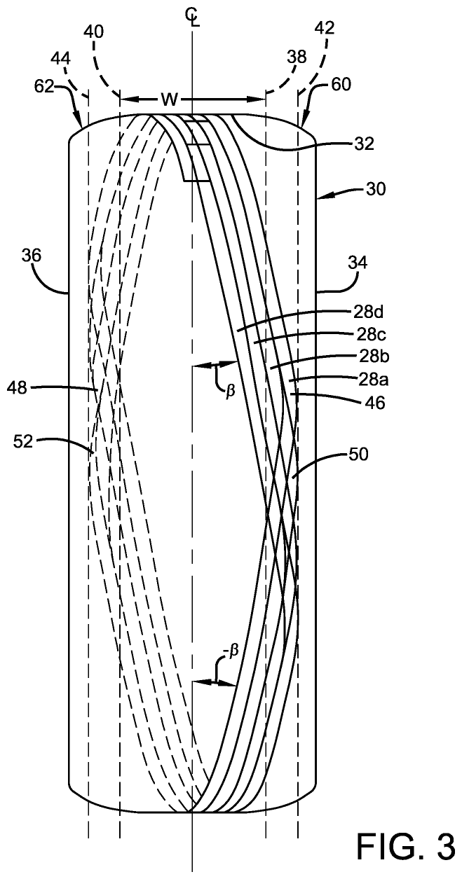

Turning now to FIGS. 2 and 3, the method includes providing a tire building drum 30 for forming the zigzag belt structure 28. The tire building drum 30 includes an axially-extending circumferential center section 32, an axially-disposed circumferential first edge 34, and an axially-disposed circumferential second edge 36. The center section 32 preferably is formed with a slight radius as will be described in greater detail below, and includes a width indicated at W. At a first edge 38 of the center section 32, the drum 30 is formed with a first end surface indicated at 60 that extends radially inwardly to the drum first edge 34. At a second edge 40 of the center section 32, the drum 30 is formed with a second end surface indicated at 62 that extends radially inwardly to the drum second edge 36.

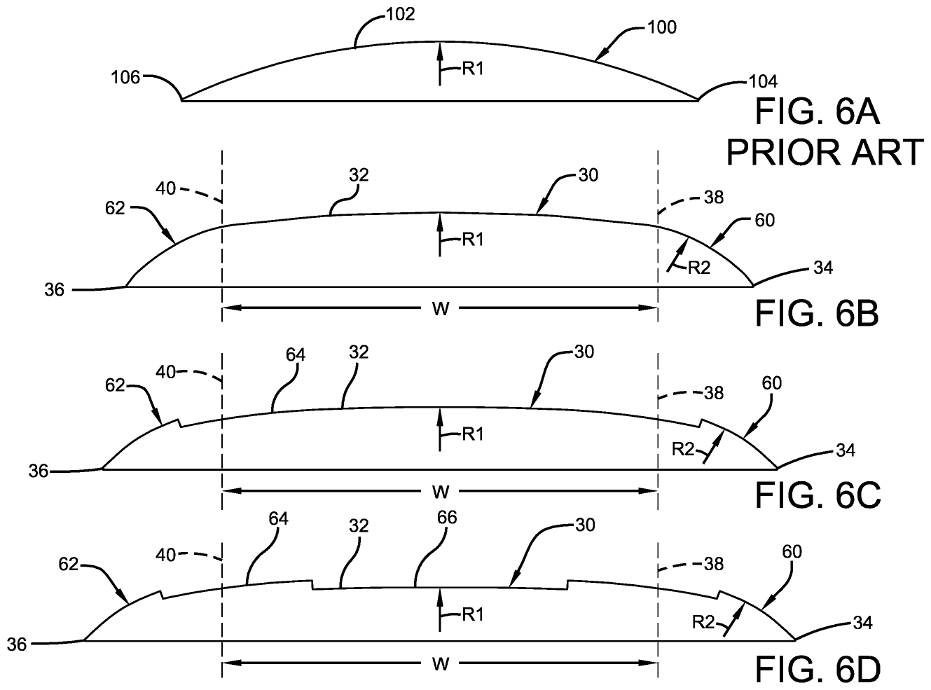

Referring to FIGS. 6B through 6D, aspects of the surface of the drum 30 are shown in comparison to the surface of a prior art drum 100, which is shown in FIG. 6A. The prior art drum 100 includes a surface 102 that extends from an axially-disposed circumferential first edge 104 to an axially-disposed circumferential second edge 106. The surface 102 of the prior art drum 100 is formed with a single slight curve or radius R1. In contrast, the tire building drum 30 used in the method of the invention is formed with a compound surface.

More particularly, as shown in FIGS. 3 and 6B, the center section 32 of the drum 30 is formed with the slight curve or radius R1, which is referred to as a first radius. The first radius R1 extends for the width W from the first edge 38 of the center section 32 to the second edge 40 of the center section. At the first edge 38 of the center section 32, the curvature of the drum 30 changes, as the first end surface 60 extends to the drum first edge 34 at a second radius R2, which is smaller than the radius R1. At the second edge 40 of the center section 32, the curvature of the drum 30 also changes, as the second end surface 62 extends to the drum second edge 36 again at the second radius R2. As mentioned above, the value of the second radius R2 is smaller than the value of the first radius R1. Preferably, a ratio of the value of the first radius R1 to the value of the second radius R2 is in a range of from about 1.5 to about 30, and is more preferably in range of from about 5 to about 15.

As shown in FIG. 6C, the drum 30 may include a recess 64, which provides a specific structural area on which the radially inner belt structure 24 (FIG. 1) may seat during the forming of the belt reinforcing package 22. As shown in FIG. 6D, the drum 30 may also include the first recess 64 and a second recess 66 to provide a structural area for multiple belt structures to seat during the forming of the belt reinforcing package 22. In any event, the center section 32 of the drum 30 is formed with the first radius R1, and each of the first end surface 60 and the second end surface 62 between the center section and each respective drum edge 34 and 36 is formed with the second radius R2.

Returning to FIGS. 2 and 3, to form the zigzag belt structure 28, the drum 30 is rotated as each one of individual strips 28a, 28b, 28c and 28d, which are shown by way of example, are wound about the drum in a circumferential direction extending in an alternating fashion between the drum edges 34 and 36, as will be explained in greater detail below. Each strip 28a, 28b, 28c and 28d is formed of rubber and is reinforced with a plurality of cords. The width of each strip 28a, 28b, 28c and 28d is typically between about 0.25 inches and 1.0 inches, and the cords preferably are formed from nylon, aramid, a combination of nylon and aramid, polyester or steel.

During winding, a first strip 28a is wound about the drum 30 at a first predetermined winding angle indicated by β. As the first strip 28a passes the first edge 38 of the center section 32 heading toward the first drum edge 34, the strip reaches a first plane 42 on the first end surface 60, which is the axial outer limit for the strip winding. At that point, referred to as a turn 46, the first strip 28a is turned in a shallow U-direction and angled at a second winding angle, which preferably is an opposing winding angle, indicated by −β. As the first strip 28a passes the second edge 40 of the center section 32 hearing toward the second drum edge 36, the strip reaches a second plane 44 on the second end surface 62 that is the opposing axial limit for the strip winding. At that point, referred to as a turn 48, the first strip 28a is turned in a shallow U-direction and angled at the winding angle of β. Preferably, the winding angle β is in a range of from about 5 to about 20 degrees.

After the first strip 28a has been wrapped about the drum 30 in this manner, a second strip 28b is shifted or offset in a circumferential manner from the first strip and then wrapped about the drum adjacent the first strip in a manner similar to that as the first strip. The second strip 28b thus includes turns 50 and 52 that are offset from the respective turns 46 and 48 of the first strip 28a. A third strip 28c and a fourth strip 28d are each wrapped about the drum 30 in a similar offset fashion, continuing to create multiple layers and thus form a belt, which continues again for multiple belts that form the zigzag belt package 28. It is to be understood that the strips 28a, 28b, 28c and 28d may be disposed in abutment with one another, overlapping one another, or spaced apart from one another. Moreover, while the strips 28a, 28b, 28c and 28d of the exemplary belt package 28 include two turns, depending on the winding angle of each strip, the diameter of the drum 30, the width of the drum and other characteristics, the strips may include more than two turns.

As described above, in the prior art, the change of direction of the strips using a single-curved or flat-surfaced drum may create a length differential between the cords on the outside edge of the strip and the cords on the inside of the strip, as well as a difference in tension between the cords on the outside edge of the strip and the inside edge of the strip, and non-uniform spacing between the cords. The drum 30 for forming the tire 10 reduces these issues by providing a center section 32 with a first radius R1 and end surfaces 60 and 62 that each have a second radius R2, which is referred to as a double-curved drum.

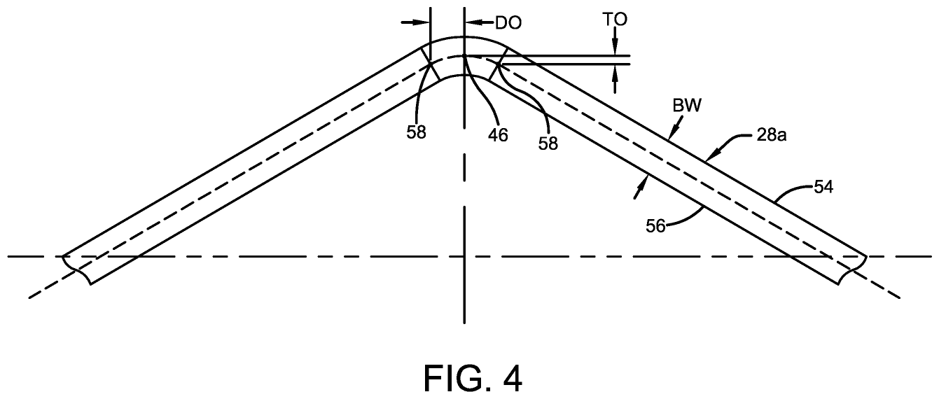

More particularly, referring to FIG. 4, the strip 28a includes an axially outer edge 54, an axially inner edge 56 and a thickness BW. The cords in the axially outer edge region 54 would have a higher tension, longer length and compressed spacing compared to the cords in the region of the axially inner edge 56 using a prior art drum. Winding the strip 28a on the double curved drum 30 reduces the differential between the cords in the outer edge 54 and the inner edge 56 to zero or near-zero. When the cord lengths are equal, they are also in equal tension and have generally uniform spacing after curing. Such reduction of the length and tension differential between the cords in the strip outer edge 54 and the strip inner edge 56 is accomplished by optimizing certain parameters.

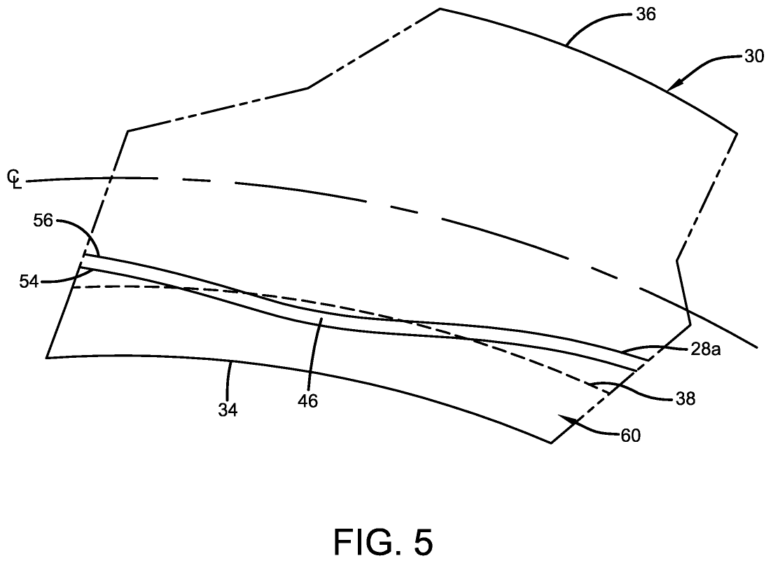

First, as shown in FIGS. 4 and 5, by making the turn 46 on the first end surface 60 of the drum 30 (as well as the turn 48 on the second end surface 62, which is not shown in FIGS. 4 and 5), the contoured surface of the drum compensates for the winding angle β (FIG. 3) of the strip with the radius R2 on the drum. The radius R2 of the first end surface 60 of the drum 30 thus creates equal tension in each edge 54 and 56 of the strip 28a. To enable such equal tension, a ratio of the value of the radius R1 of the center section 32 to the value of the radius R2 of the first end surface 60 (as well as to the value of the radius R2 of the second end surface 62) preferably is in a range of from about 1.5 to about 30. For example, when the winding angle β of the belts 28a, 28b, 28c and 28d is between about 5 degrees to about 20 degrees, the ratio of radius R1 to radius R2 may be in a range of from about 5 to about 15. When the strips 28a, 28b, 28c and 28d are of a relatively wide width, the ratio of R1 to radius R2 will be higher than when the strips are of a relatively narrow width.

Next, the width BW of the strip 28a may be optimized to promote a length and tension of the cords in the axially outer edge region 54 that are equal to the length and tension of the cords in the axially inner edge 56 region, taking into account the double-curved drum 30. For example, the width BW of the strip 28a preferably is between about 0.25 inches and about 1.0 inches. In addition, the width of the entire belt package 28 may be optimized to promote a length and tension of the cords in the axially outer edge region 54 of each respective strip 28a, 28b, 28c and 28d that are equal to the length and tension of the cords in the axially inner edge 56 region of each strip.

Another parameter that may be optimized is the traverse offset TO. The traverse offset TO is the axial distance at the center of the strip 28a from the center of the turn 46 to the point 58 at which the turn ends and the strip continues in a straight line along the drum 30. A higher traverse offset TO undesirably increases the length and tension differential between the cords in the axially outer edge region 54 and the cords in the axially inner edge region 56. The double-curved drum 30 desirably reduces the traverse offset TO effect, thereby decreasing the length and tension differential between the cords in the axially outer edge region 54 and the cords in the axially inner edge region 56 to zero or near zero.

A further parameter that may be optimized is the drum offset DO. The drum offset DO is the circumferential distance at the center of the strip 28a from the center of the turn 46 to the point 58 at which the turn ends and the strip continues in a straight line along the drum 30. A lower drum offset DO creates a sharper turn 46 that undesirably increases the length and tension differential between the cords in the axially outer edge region 54 and the cords in the axially inner edge region 56. The double-curved drum 30 desirably reduces the drum offset DO effect, thereby creating a smoother turn 46, which decreases the length and tension differential between the cords in the axially outer edge region 54 and the cords in the axially inner edge region 56 to zero or near zero.

These parameters may be optimized in several ways. For example, when the contour of the double-curved drum 30 has been established, the remaining winding parameters may be adjusted to reach equal tension between the cords in the axially outer edge region 54 and the cords in the axially inner edge region 56 of the strip 28a. Alternatively, the contour of the double-curved drum 30 may be adjusted in view of established remaining winding parameters to reach equal tension between the cords in the axially outer edge region 54 and the cords in the axially inner edge region 56 of the strip 28a. As another alternative, the contour of the double-curved drum 30 and the remaining winding parameters may all be adjusted during design to reach equal tension between the cords in the axially outer edge region 54 and the cords in the axially inner edge region 56 of the strip 28a.

Therefore, the present invention includes a method of forming a belt structure 28 for a tire 10. The method includes steps in accordance with the description that is presented above and shown in FIGS. 1 through 5 and 6B through 6D.

In this manner, the tire 10 including the zigzag belt structure 28 formed on the double-curved drum 30 optimizes zigzag winding parameters of the strips 28a, 28b, 28c and 28d to promote a uniform tension on the cords in each strip, a uniform length of the cords across each strip, and uniform spacing between the cords in each strip. Such uniform tension, length and spacing of the cords in each strip 28a, 28b, 28c and 28d desirably increases the strength of zigzag belt structure 28 and thus the belt reinforcing package 22. The uniform tension, length and spacing also balances the strain and stress of the cords in each strip 28a, 28b, 28c and 28d to desirably increase the durability of the edge of the zigzag belt structure 28. Moreover, the uniform tension, length and spacing of the cords in each strip 28a, 28b, 28c and 28d improves the uniformity of the zigzag belt structure 28 and thus the belt reinforcing package 22 to promote desirable uniform wear of the tire tread 18.

It is to be understood that the method of forming and/or the structure of the above-described tire 10, zigzag belt structure 28 and/or double-curved drum 30 may be altered or rearranged, or components or steps known to those skilled in the art omitted or added, without affecting the overall concept or operation of the invention. In addition, the number, arrangement, sequence of winding and/or compositions of the strips 28a, 28b, 28c and 28d and their manner of forming belt layers and the zigzag belt structure 28 may be adjusted or changed based upon particular design considerations without affecting the overall concept or operation of the invention.

The invention has been described with reference to a preferred embodiment. Potential modifications and alterations will occur to others upon a reading and understanding of this description. It is to be understood that all such modifications and alterations are included in the scope of the invention as set forth in the appended claims, or the equivalents thereof.

What is claimed is:

1. A method of forming a belt structure for a pneumatic tire, the method comprising the steps of:
providing a drum, the drum including:
an axially-extending circumferential center section, the center section including a first center section edge and a second center section edge, the center section being formed with a first radius of curvature, the first radius of curvature extending from the first center section edge to the second center section edge;
an axially-disposed circumferential drum first edge near the first edge of the center section;
an axially-disposed circumferential drum second edge near the second edge of the center section;
a first end surface extending radially inwardly from the first edge of the center section to the drum first edge and including a second radius of curvature that is smaller than the first radius of curvature;
a second end surface extending radially inwardly from the second edge of the center section to the drum second edge and including the second radius of curvature; and
a surface recess for receiving a radially inner belt structure;
providing at least one strip, the at least one strip being reinforced by a plurality of cords and including an axially outer edge and an axially inner edge;
winding the at least one strip about the drum in a circumferential direction between the first and second drum edges; and
turning the at least one strip from a first winding angle to a second winding angle on the first end surface, whereby the turning reduces a difference of at least one of a length between cords disposed adjacent the axially outer edge of the at least one strip and cords disposed adjacent the axially inner edge of the at least one strip, and a tension between the cords disposed adjacent the axially outer edge of the at least one strip and the cords disposed adjacent the axially inner edge of the at least one strip.

2. The method of forming the belt structure for the pneumatic tire of claim 1, further comprising the step of turning the at least one strip from the second winding angle back to the first winding angle on the second end surface.

3. The method of forming the belt structure for the pneumatic tire of claim 1, wherein the step of turning the at least one strip includes the first winding angle being in a range of from about 5 to about 20 degrees.

4. The method of forming the belt structure for the pneumatic tire of claim 1, wherein the step of turning the at least one strip includes the first winding angle and the second angle being at opposing angles such that an absolute value of the first winding angle is equal to an absolute value of the second winding angle.

5. The method of forming the belt structure for the pneumatic tire of claim 1, wherein the step of providing the drum includes a ratio of a value of the first radius of curvature to a value of the second radius of curvature is from about 1.5 to about 30.

6. The method of forming the belt structure for the pneumatic tire of claim 5, wherein the ratio is from about 5 to about 15.

7. The method of forming the belt structure for the pneumatic tire of claim 1, wherein the at least one strip is a first strip, and the method further comprises the step of offsetting a second strip in a circumferential manner from the first strip and winding the second strip about the drum.

8. The method of forming the belt structure for the pneumatic tire of claim 1, wherein the step of providing at least one strip includes a width of the at least one strip being between about 0.25 inches and 1.0 inches.

9. The method of forming the belt structure for the pneumatic tire of claim 1, wherein the step of providing at least one strip includes the cords being formed from at least one of nylon, aramid, a combination of nylon and aramid, polyester, and steel.

10. The method of forming the belt structure for the pneumatic tire of claim 1, wherein the step of providing the drum includes reducing a traverse offset of the at least one strip.

11. The method of forming the belt structure for the pneumatic tire of claim 1, wherein the step of providing the drum includes increasing a drum offset of the at least one strip.

12. The method of forming the belt structure for the pneumatic tire of claim 1, wherein the step of providing the drum includes the drum being formed with a second surface recess for receiving a second radially inner belt structure.
